(19) United States
(12) Patent Application Publication
(10) Pub. No.: US 2015/0330356 A1
(43) Pub. Date: Nov. 19, 2015

(54) ENERGY CONVERSION APPARATUS

(71) Applicant: Otello GNANI, (US)

(72) Inventor: Otello GNANI, Bologna (IT)

(21) Appl. No.: 14/655,699

(22) PCT Filed: Nov. 27, 2013
(86) PCT No.: PCT/EP2013/074866

§ 371 Date: Jun. 25, 2015

(30) Foreign Application Priority Data
Jan. 3, 2013 (IT) BO2013A000004

(51) Int. Cl. F03B 13/06; F03B 13/10; F03C 1/22

(52) U.S. Cl. CPC F03B 13/06; F03C 1/22; F03B 13/10

(57) ABSTRACT

An energy conversion apparatus includes a duct that can be passed through by a transfer liquid and is intercepted by a respective turbine, which is moved by the transfer liquid to generate electricity, by means of an alternator that can be associated with the turbine. The duct includes a delivery pipe interposed between at least two tanks of the transfer liquid, and the turbine; respective pistons are configured to slide hermetically, alternately, and cyclically inside the two tanks for their alternating emptying and consequent sending of the liquid to the turbine through the delivery pipe. The duct further includes a return pipe interposed between the turbine and the two tanks, for the alternating sending of the transfer liquid to the corresponding tank that was previously emptied, after the movement of the turbine to generate electricity, and the consequent restoring of the level of the transfer liquid.

### FIELD

The present disclosure relates to an energy conversion apparatus.

### BACKGROUND

As is known, in several parts of the world the use is frequent of power stations that can convert a primary energy source to electricity, which will subsequently be transmitted and distributed to users by means of high, low and medium tension lines, for widely varying purposes and uses.

Over time, different types of electric power station have thus been devised and improved, each of which is capable of converting a specific form of energy according to a yield thereof, and with peculiar advantages and disadvantages (which are also influenced by the development of new technologies), which are such as to determine their adoption or, occasionally, their progressive abandonment.

Among the different types of systems of the type outlined above, today hydroelectric power stations are widespread and are capable of converting the gravitational potential energy, possessed by a mass of water which is located at a certain height, into electricity, thanks to a turbine, associated with an alternator, which is arranged lower down and is made to rotate by the mass of water falling from the height mentioned above.

The mass of water can belong to a natural or artificial water basin (or even to a river, in order to take advantage of its naturally possessed kinetic energy), and can conveniently be conveyed toward the turbine by means of especially provided ducts. In any case, it is a method of obtaining electricity that is of great interest, especially because of the limited, or nil, production of pollutant wastes (consider, for example, the total lack of production of exhaust gases and pollutant gases, which occurs when using thermal power stations, or the problems connected with the use of nuclear power stations), and because of the ability to use a primary energy source (water) that is completely renewable.

It further appears evident that such systems necessitate high installation and implementation costs, which are such as to render their adoption inadvisable and wholly non-economic, for meeting small-scale needs or for local, small grids.

Thus attempts are frequently made to provide hydroelectric power stations that are capable of ensuring optimal performance levels, while at the same time retaining the above peculiar characteristics, even if used to meet small-scale needs or the needs of isolated population centers.

The aim of the present disclosure is to solve the above mentioned problems, by providing an energy conversion apparatus that is capable of ensuring high performance levels without the emission of gases or other pollutant waste products into the environment.

### SUMMARY

Within this aim, an object of the disclosure is to provide an energy conversion apparatus that is versatile, and is also suitable for small-scale needs.

A further object of the disclosure is to provide an energy conversion apparatus that ensures a high reliability of operation.

Another object of the disclosure is to provide an energy conversion apparatus that can be easily implemented using elements and materials that are readily available on the market.

Another object of the disclosure is to provide an energy conversion apparatus that is low cost and safely applied.

This aim and these objects are achieved by an energy conversion apparatus, comprising a duct that can be passed through by a transfer liquid and intercepted by a respective turbine, which is moved by the transfer liquid to generate electricity, by means of an alternator that can be associated with said turbine, characterized in that said duct comprises a delivery pipe, which is interposed between at least two tanks of the transfer liquid, which are arranged in parallel, and said turbine, respective pistons being able to slide hermetically, alternately and cyclically inside said at least two tanks for their alternating emptying and consequent sending of the liquid to said turbine through said delivery pipe, said duct comprising a return pipe, which is interposed between said turbine and said at least two tanks, for the alternating sending of the transfer liquid to the corresponding said tank that was previously emptied, after the movement of said turbine to generate electricity, and the consequent restoring of the level of the transfer liquid.

### BRIEF DESCRIPTION OF THE DRAWINGS

Further characteristics and advantages of the disclosure will become better apparent from the description of a preferred, but not exclusive, embodiment of the apparatus according to the disclosure, which is illustrated by way of non-limiting example in the accompanying drawings wherein:

FIGS. 1 and 2 are views of the operation of the energy conversion apparatus according to the disclosure, and show the alternating movement of the two pistons.

### DETAILED DESCRIPTION OF THE DRAWINGS

With reference to the figures, the reference numeral 1 generally designates an energy conversion apparatus that comprises a duct that can be passed through by a transfer liquid A and is intercepted by a turbine 2, which is moved by the transfer liquid A to generate electricity, according to substantially conventional methods, and for example by means of an alternator 3 that can be associated with the turbine 2.

It should be noted from this point onward that the generation of electricity by means of the alternator 3, which takes mechanical energy from the turbine 2, constitutes the preferred application of the apparatus 1 according to the disclosure, and constant reference shall be made to it in the present discussion, but the possibility is not ruled out of using and converting the mechanical energy made available by the turbine 2, as a result of its being passed through by the transfer liquid A, in a different manner according to specific requirements.

It should be further noted that the transfer liquid A is preferably water, although different types of liquid A can be used if the circumstances make it advisable, and, similarly, the type of turbine 2 can also be selected at will (Pelton, Francis, Michell-Banki etc.).

According to the disclosure, the duct comprises a delivery pipe 4, which is interposed between at least two tanks 5a and 5b of the transfer liquid A, which are arranged in parallel, and the turbine 2: respective pistons 6a and 6b are able to slide hermetically, alternately and cyclically inside the two tanks 5a and 5b, and are capable of alternately emptying the tanks 5a, 5b, as a consequence, sending the liquid A to the turbine 2 through the delivery pipe 4.

Moreover, the duct comprises a return pipe 7, which is interposed between the turbine 2 and the two tanks 5a and 5b, in order to allow, after the movement of the turbine 2 to generate electricity, the alternating sending of the transfer liquid A to the corresponding tank 5a and 5b that was previously emptied, in order to restore, as a consequence, the level of the transfer liquid A thus rendering the tank 5a, 5b available for performing a new work step.

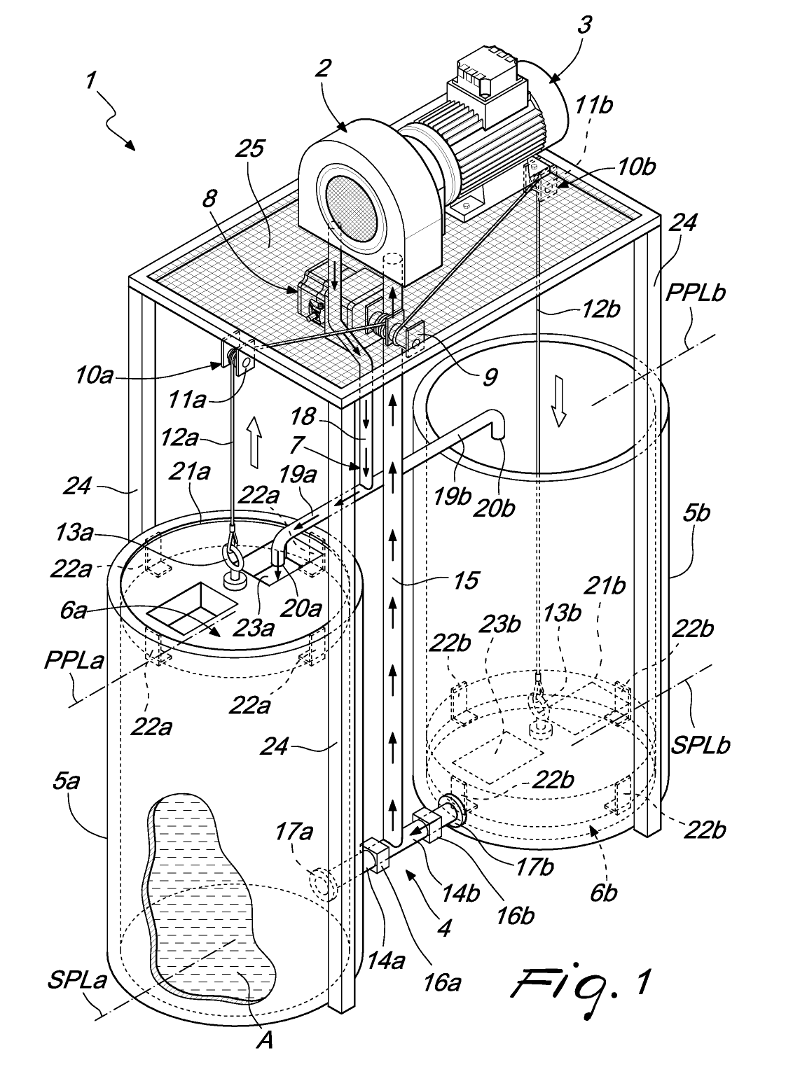

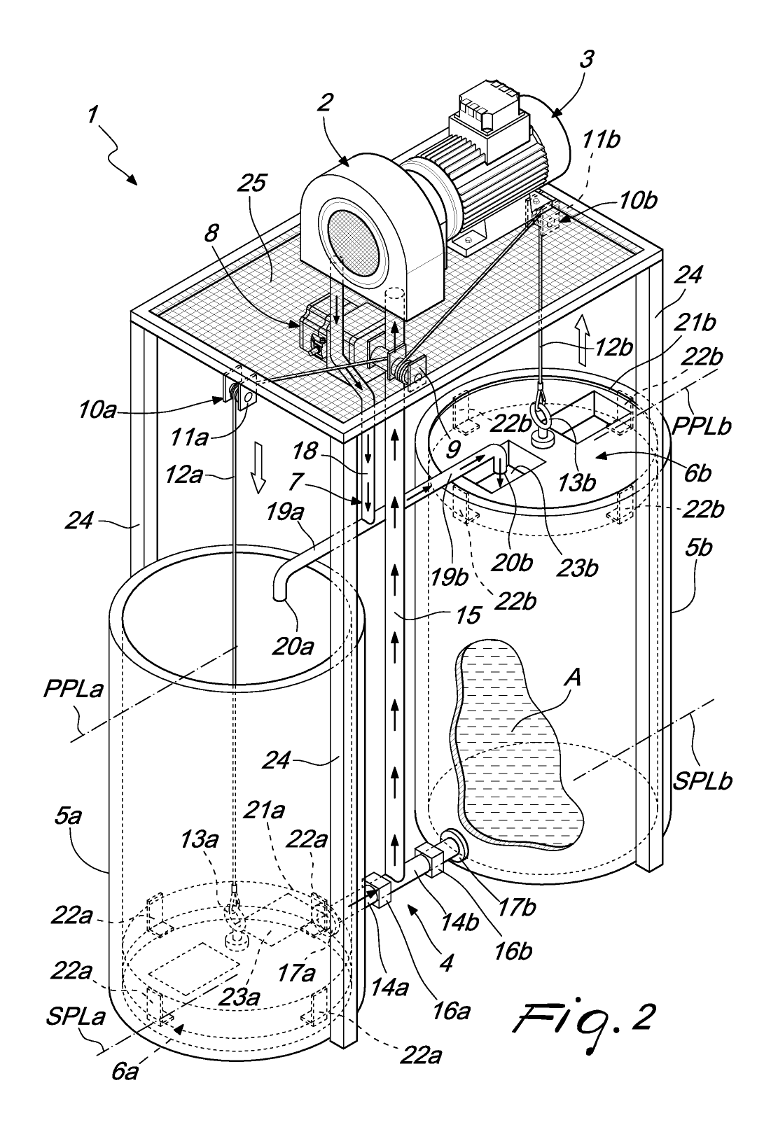

In particular, each piston 6a, 6b can move within the respective tank 5a, 5b along a vertical sliding direction, so as to enable the automatic transition, by simple gravity, of the piston 6a, 6b from a first limit position (indicated with PPLa, PPLb in the accompanying figures and in which the tank 5a is shown in FIG. 1), corresponding to the substantially complete filling of the respective tank 5a, 5b, to a second limit position (indicated with SPLa, SPLb in the accompanying figures and in which the tank 5b is shown in FIG. 1), corresponding to the substantially complete emptying of the respective tank 5a, 5b.

Moreover, the energy conversion apparatus 1 comprises movement means 8 for moving each piston 6a, 6b, in order to allow the sliding thereof in the opposite direction, and thus from the second limit position SPLa, SPLb to the first limit position PPLa, PPLb.

More specifically, in the embodiment shown in the accompanying figures, for the purposes of a non-limiting example of the application of the disclosure, the movement means 8 comprise an electrically motorized winch 9, which is functionally associated with the pistons 6a, 6b by means of respective transmission elements 10a, 10b, for lifting them from the second limit position SPLa, SPLb to the first limit position PPLa, PPLb.

During the sliding of each piston 6a, 6b from the first limit position PPLa, PPLb to the second limit position SPLa, SPLb, the winch 9 can effectively control the movement of descent by gravity, thus ensuring that this occurs according to a predefined law of motion, and thus preventing it from occurring, for example, at excessively high speeds, which could cause malfunctions or damages or modify the flow of the transfer liquid A.

In a possible embodiment, the transmission elements 10a, 10b comprise, for each tank 5a, 5b, a pulley 11a, 11b that surmounts it and around which is partially wound a respective cable 12a, 12b, which at one end is coupled to the winch 9 and which at the other end is fixed to a hook 13a, 13b that is integral with the piston 6a, 6b.

It is the use of the same winch 9 to lift a piston 6a, 6b and simultaneously adjust and control the descent of the other piston 6b, 6a that makes it possible to reduce the stresses by balancing the forces, and thus contain the necessary power of the electric motor for driving the winch 9.

In any case, in a different embodiment, the movement means 8 can comprise two electrically motorized winches 9, each one of which is functionally associated with, possibly by means of corresponding transmission elements 10a, 10b, a respective piston 6a, 6b, in order to lift it from the second limit position SPLa, SPLb to the first limit position PPLa, PPLb.

It should be noted that it is possible, to use movement means 8 of different type, according to specific requirements.

As can be seen from the accompanying figures, shown by way of a non-limiting example of the application of the disclosure, the delivery pipe 4 is substantially T-shaped so as to define two first parallel branches 14a, 14b, which are arranged downstream of respective tanks 5a, 5b and which converge in a first common portion 15, which leads to the turbine 2: each first parallel branch 14a, 14b is intercepted by a respective adjustment valve 16a, 16b, which can be selectively actuated in order to adjust the alternating sending of the transfer liquid A to the turbine 2.

Preferably, each one of such first parallel branches 14a, 14b is associated with the respective tank 5a, 5b through a delivery port 17a, 17b provided at the base of the tank 5a, 5b.

The adjustment valves 16a, 16b can be selected and dimensioned to normally keep the respective first parallel branch 14a, 14b closed and can be such as to allow the transition of a predefined flow rate of transfer liquid A only following a flow (with adequate pressure) originating from the corresponding tank 5a, 5b located upstream.

Moreover, the extent of the passage opening defined by the adjustment valves 16a, 16b can be selectively modifiable by the user, in order to control and adjust the flow rate inside the delivery pipe 4 as a consequence.

Similarly, the return pipe 7 is also substantially T-shaped, so as to define a second common portion 18, which is arranged below the turbine 2 to collect, by gravity (and optionally by means of an adapted manifold) the transfer liquid A, after the movement of the turbine 2 to generate electricity, and two second parallel branches 19a, 19b, which are arranged downstream of the second common portion 18 and lead, with a respective discharge outlet 20a, 20b, to a corresponding tank 5a, 5b.

Conveniently, each tank 5a, 5b is substantially cylindrical (although the possibility is not ruled out of providing tanks 5a, 5b that are square or rectangular in cross-section), and each piston 6a, 6b comprises a disk-like body 21a, 21b, which can slide hermetically along the inner lateral surface of the corresponding substantially cylindrical tank 5a, 5b in order to empty it during the transition from the first limit position PPLa, PPLb to the second limit position SPLa, SPLb.

Precisely in order to allow an optimal sliding of the disk-like bodies 21a, 21b, the possibility exists of providing each one of these with guide runners 22a, 22b, which are provided with needle rollers rolling along the inner lateral surface of the tank 5a, 5b, in order to prevent the possible warping of one of the disk-like bodies 21a, 21b during ascent or descent, for example owing to an unbalancing of the loads transmitted by the winch 9 through the transmission elements 10a, 10b.

Positively, each piston 6a, 6b can comprise a plurality of additional masses, the number of which is preset (and conveniently selected by the installation technician or by the user), which can be associated with the disk-like body 21a, 21b (or in any case with the piston 6a, 6b) in order to vary its weight and the pressure obtained for the transfer liquid A in a controlled manner: this makes it possible, as a consequence, to adjust the speed of sliding from the first limit position PPLa, PPLb to the second limit position SPLa, SPLb and thus the flow rate of the transfer liquid A inside the delivery pipe 4 and the pressure.

It can thus immediately be seen that by being able to vary at will the flow rate inside the delivery pipe 4, and thus of the turbine 2, it is possible to modify the power that can be dispensed by the turbine 2, in that, as is known, such power is directly proportional to the flow rate of the transfer liquid A that passes through it (according to the known formula P=9.81*Q*H*η, where P is the power generated, expressed in kW/h, Q is the flow rate in m³/second, H is the height of the column of water or other transfer liquid A in meters or in bar—one ten-meter water column being equivalent to one bar of pressure—and η is the yield of the system).

Conveniently, each disk-like body 21a, 21b comprises at least one respective orifice 23a, 23b that is surmounted by a respective discharge outlet 20a, 20b, in order to allow the automatic filling of the tank 5a, 5b that was previously emptied, by simple falling of the transfer liquid A from the respective second parallel branch 19a, 19b of the return pipe 7, during or following the transition of the corresponding piston 6a, 6b from the second limit position SPLa, SPLb to the first limit position PPLa, PPLb. Moreover, each piston 6a, 6b comprises at least one gate, which can be selectively positioned to close a respective orifice 23a, 23b, during the transition of the piston 6a, 6b from the first limit position PPLa, PPLb to the second limit position SPLa, SPLb, and thus enable the emptying of the tank 5a, 5b.

Advantageously, the conversion apparatus 1 according to the disclosure comprises a supporting frame, which is provided with four posts 24 which are associated in an upper region with a supporting platform 25 for the turbine 2, such platform 25 (as can be seen from the accompanying figures, by way of non-limiting example) having a grid-like structure in order to allow its passing through by the common portions 15, 18 of the delivery pipe 4 and of the return pipe 7.

Operation of the apparatus according to the disclosure is the following.

Thanks to the pressure of the water (or other transfer liquid A), which in turn is moved by the piston 6a, 6b that descends in the respective tank 5a, 5b by gravity, it is possible to produce electricity in quantities proportional to the weight of the pistons 6a, 6b, which in turn can be varied at will, by using, as previously noted, one or more attachable additional masses.

In more detail, as soon as a first piston 6a is allowed to descend (at controlled speed, thanks to the action of the winch 9) from the first limit position PPLa to the second limit position SPLa, the transfer liquid A is pushed inside the respective first parallel branch 14a of the delivery pipe 4, automatically opening the adjustment valve 16a (and closing the other adjustment valve 16b). From there, the water under pressure is conveyed to the first common portion 15 and thus to the turbine 2, which is made to rotate, thus making it possible to produce electricity through, for example, an alternator 3.

While the first piston 6a descends in the respective tank 5a, the other piston 6b ascends, lifted by the winch 9, from the second limit position SPLb to the first limit position PPLb, in order to allow the other tank 5b, which was previously emptied, to fill again with the transfer liquid A that falls from the turbine 2 through the second parallel branch 19b (and thanks to the respective gate which, in this step, does not close the orifice 23b).

More precisely, the gates can be conveniently selected to open automatically by mechanical action in the absence of pressure, and thus facilitate an optimal behavior of the apparatus 1 according to the disclosure.

Moreover it should be noted that the possibility exists of providing the second parallel branches 19a, 19b of the return pipe 7 with further mechanically or electrically actuated shut-off valves, precisely in order to control the sending of the water to the tank 5a, 5b that was previously emptied, thus preventing this water from being accidentally conveyed to the other, during the emptying step.

So in fact, when the first piston 6a reaches the second limit position SPLa, the other piston 6b reaches the first limit position PPLb.

At this point, the inversion of the direction of rotation of the winch 9 (with simultaneous inversion of the open/closed configuration of the orifices 23a, 23b and of the shut-off valves mentioned above) determines the inversion of the direction of travel of the pistons 6a, 6b: the winch 9 can thus lift, from the second limit position SPLa to the first limit position PPLa, the first piston 6a mentioned above, which can move within the tank 5a that was emptied during the previous work step described above. Inside the first tank 5a the water can thus fall automatically, by gravity, after having passed through the second common portion 18 of the return pipe 7 and thus the respective second parallel branch 19a.

At the same time, the piston 6b associated with the other tank 5b can descend by gravity and thus determine the emptying of the latter (thanks to the automatic opening of the respective adjustment valve 16b, while the other adjustment valve 16a is closed), to feed the turbine 2 with more water and thus continue the production of electricity.

The two steps illustrated above, in which each piston 6a, 6b alternately slide between the respective limit positions PPLa, SPLa, PPLb, SPLb inside the corresponding tank 5a, 5b, can be cyclically repeated in order to ensure the production of electricity (twenty-four hours a day if desired) by means of a structurally simple solution, without requiring complex maintenance and installation and/or access to natural water basins (or even the creation of artificial water basins), thus allowing its application for small-scale use or isolated population centers (and further offering the possibility of selling any energy surplus produced to the national grid).

The production of electricity is achieved thanks to the movement of the pistons 6a, 6b (by simple gravity and with a contained consumption of electricity, for the operation of the winch 9) and by exploiting the kinetic energy of the water, thus in a totally renewable manner, without the emission of gases or other pollutant waste products into the environment.

Moreover, simply by varying the size of the tanks 5a, 5b, the quantity of water (or other transfer liquid A) circulating in the duct, and the weight of each disk-like body 21a, 21b (thanks to the additional masses), it is possible to adjust the power dispensed by the turbine 2 at will, increasing it if high performance levels are required, and in any case rendering the apparatus 1 according to the disclosure totally versatile.

In practice it has been found that the apparatus according to the disclosure fully achieves the set aim, in that the use of a duct that comprises a delivery pipe and a return pipe, interposed between a turbine and two tanks which are arranged in parallel, in which respective pistons are able to slide hermetically, alternately and cyclically, for their alternating emptying and the alternating sending of the transfer liquid to the corresponding tank that was previously emptied, after the turbine has been moved in order to generate electricity, makes it possible to provide an energy conversion apparatus that is capable of ensuring high performance levels without the emission of gases or other pollutant waste products into the environment.

The disclosure thus conceived is susceptible of numerous modifications and variations, all of which are within the scope of the appended claims; moreover, all the details may be substituted by other, technically equivalent elements.

For example, the possibility exists of providing apparatuses 1 in which three or more pistons 6a, 6b slide alternately, according to appropriate mutually coordinated laws of motion, in respective tanks 5a, 5b which are arranged in parallel.

Moreover, along the first parallel branches 14a, 14b there are adapted meters of pressure and flow rate of the transfer liquid A that passes through it, in order to command the opening and closing of the adjustment valves 16a, 16b and the speed of descent of the pistons 6a, 6b, in order to obtain the capacity (Q) desired and control the pressure obtained with the weight of the pistons 6a, 6b themselves.

In the embodiments illustrated, individual characteristics shown in relation to specific examples may in reality be interchanged with other, different characteristics, existing in other embodiments.

In practice, the materials employed, as well as the dimensions, may be any according to requirements and to the state of the art.

The disclosures in Italian Patent Application No. BO2013A000004 from which this application claims priority are incorporated herein by reference.

1-10. (canceled)

11. An energy conversion apparatus, comprising a duct that can be passed through by a transfer liquid and intercepted by a respective turbine, which is moved by the transfer liquid to generate electricity, by means of an alternator that can be associated with said turbine, wherein said duct comprises a delivery pipe, which is interposed between at least two tanks of the transfer liquid, which are arranged in parallel, and said turbine, respective pistons being able to slide hermetically, alternately and cyclically inside said at least two tanks for their alternating emptying and consequent sending of the liquid to said turbine through said delivery pipe, said duct comprising a return pipe, which is interposed between said turbine and said at least two tanks, for the alternating sending of the transfer liquid to the corresponding said tank that was previously emptied, after the movement of said turbine to generate electricity, and the consequent restoring of the level of the transfer liquid.

12. The energy conversion apparatus according to claim 11, wherein each one of said pistons can move within the respective said tank along a vertical sliding direction, for the automatic transition, by gravity, from a first limit position, which corresponds to the substantially complete filling of the respective said tank, to a second limit position, which corresponds to the substantially complete emptying of the respective said tank.

13. The energy conversion apparatus according to claim 11, further comprising means for moving each one of said pistons from said second limit position to said first limit position.

14. The energy conversion apparatus according to claim 13, wherein said movement means comprise an electrically motorized winch which is functionally associated with said pistons, by means of respective transmission elements, for their lifting from said second limit position to said first limit position.

15. The energy conversion apparatus according to claim 13, wherein said movement means comprise two electrically motorized winches, each one of said winches being associated functionally with a respective said piston, for its lifting from said second limit position to said first limit position

16. The energy conversion apparatus according to claim 11, wherein said delivery pipe is substantially T-shaped, in order to define two first parallel branches, which are arranged downstream of respective said tanks and merge into a first common portion that leads to said turbine, each one of said first parallel branches being intercepted by a respective adjustment valve that can be activated selectively to adjust the alternating sending of the transfer liquid to said turbine, said return pipe being substantially T-shaped, in order to define a second common portion, arranged below said turbine, to collect by gravity the transfer liquid after the movement of the turbine to generate electricity, and two second parallel branches, which are arranged downstream of said second common portion and lead, with a respective outlet, toward corresponding said tanks.

17. The energy conversion apparatus according to claim 12, wherein each one of said tanks is substantially cylindrical, each one of said pistons comprising a disk-like body that can slide hermetically along the inner lateral surface of the corresponding said substantially cylindrical tank, in order to empty said tank during the transition from said first limit position to said second limit position.

18. The energy conversion apparatus according to claim 17, wherein each one of said pistons comprises a plurality of additional masses, which can be associated in a predefined number with said disk-like body for the controlled variation of its weight and of the obtained pressure of the transfer liquid, and the consequent adjustment of the rate of sliding from said first limit position to said second limit position.

19. The energy conversion apparatus according to claim 17, wherein each one of said disk-like bodies comprises at least one respective orifice that is surmounted by a respective said discharge outlet for the automatic filling of said tank that was previously emptied, by gravity, of the transfer liquid, during/following the transition of the corresponding said piston from said second limit position to said first limit position, each one of said pistons comprising at least one gate, which can be positioned selectively so as to close said at least one orifice during the transition of said piston from said first limit position to said second limit position.

20. The energy conversion apparatus according to claim 16, further comprising a supporting frame, provided with four posts that are associated in an upper region with a supporting platform for said turbine, said platform having a grid-like structure for its passing through by said common portions of said delivery pipe and of said return pipe.
